(19) United States
(12) Patent Application Publication
(10) Pub. No.: US 2008/0248858 A1
(43) Pub. Date: Oct. 9, 2008

(54) Gaming Machine, Method, And Tangible Computer Readable Medium

(75) Inventor: Norio HOSOKAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Koto-ku (JP)

(21) Appl. No.: 12/057,843

(22) Filed: Mar. 28, 2008

(30) Foreign Application Priority Data
Apr. 3, 2007 (JP) JP2007-097709

(51) Int. Cl. A63F 13/00

(52) U.S. Cl. 463/20

(57) ABSTRACT

A gaming environment is described. Some symbols, which are among symbols to be displayed on a display, are shielded. A gaming session is interrupted while the symbols are shielded. If a player makes a shielding cancel operation, the shielded symbols are displayed and the gaming session is restarted.

### CROSS-REFERENCE TO RELATED APPLICATIONS

This application is based upon and claims a priority from the prior Japanese Patent Application No. 2007-097709 filed on Apr. 3, 2007, the entire contents of which are incorporated herein by reference.

### BACKGROUND

1. Field

One or more aspects of the invention relate to a gaming machine, a method, and a computer readable medium having computer-executable instructions thereof which execute games using plural symbols displayed on a display device.

2. Description of Related Art

In conventional slot machines, if gaming medium (such as medal, coin) is inserted by a player and a predetermined start operation is made, plural symbols will be variably displayed. The plural symbols which are variably displayed are stopped based on a lottery result corresponding to random number(s). A predetermined amount of gaming medium is provided to the player based on a combination of the stopped symbols.

In the conventional slot machines, gaming session is developed even though the player misses out a timing of when symbols are stopped. For example, if bonus symbols are displayed on predetermined position, the winning combination is realized and bonus payout is provided. Here, a payment of the bonus payout is made regardless whether the player check stopped symbols. Accordingly, the player can easily guess stopped symbols, an existence or nonexistence of winning combination, or the like based on subsequent game's development, even if the player misses out timing of when symbols are stopped. Also, since the player can not feel sensation of the timing of when symbols are stopped, enjoyment of game may be reduced.

### SUMMARY

One or more aspects of invention related to a gaming machine, a method thereof, a computer readable medium having computer-executable instructions or the like which nonconventional gaming environment.

Also, in one or more aspects of invention, some symbols can be shielded and gaming session is interrupted. Also, if predetermined operation is made, the gaming session is restarted. Accordingly, a player can feel sensation of the timing of when symbols are stopped, and enjoyment of game can be enhanced.

One or more of the above aspects of the invention will be more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is a perspective view showing an entirety construction of a slot machine in accordance with one or more aspects of the present invention.

FIG. 2 is a block diagram showing an internal construction of the slot machine in accordance with one or more aspects of the present invention.

FIG. 3 is a block diagram showing an internal construction of an image control circuit in accordance with one or more aspects of the present invention.

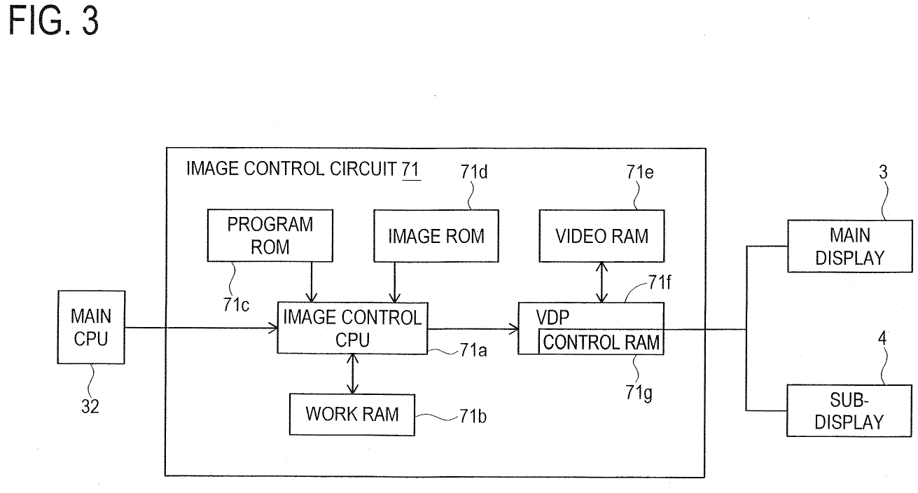

FIG. 4 is an explanatory view showing correspondence relation between symbol arrangement of a first reel to a ninth reel and code number data in accordance with one or more aspects of the present invention.

FIG. 5 is an explanatory view showing a condition where symbol data is stored in symbol storage areas in accordance with one or more aspects of the present invention.

FIG. 6 is an explanatory view showing a winning combination determination table in accordance with one or more aspects of the present invention.

FIG. 7 is a flowchart indicating an operation procedure of a main control process in accordance with one or more aspects of the present invention.

FIG. 8 is a flowchart indicating an operation procedure of coin insertion and start check process in accordance with one or more aspects of the present invention.

FIG. 9 is a flowchart indicating an operation procedure of an internal lottery process in accordance with one or more aspects of the present invention.

FIG. 10 is a flowchart indicating an operation procedure of a reel control process in accordance with one or more aspects of the present invention.

FIG. 11 is a flowchart indicating an operation procedure of a payout number determination process in accordance with one or more aspects of the present invention.

FIG. 12 is a view showing a display content of a main display during scrolled in accordance with one or more aspects of the present invention.

FIG. 13 is a view showing a condition where a part of symbols to be displayed on the main display are shielded in accordance with one or more aspects of the present invention.

FIG. 14 is a view showing a condition where shielding of the symbols is canceled and all of the symbols are displayed on the main display in accordance with one or more aspects of the present invention.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine according to one or more aspects of the invention will be described in detail with reference to the drawings based on an embodiment embodying one or more aspects of the invention as a slot game machine. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU” and “processor” are inclusive by nature, including at least one of hardware, software, or firmware.

These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server. It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

Hereinafter, an embodiment embodying one or more aspects present invention will be described in detail with reference to drawings.

### (Construction of a Slot Machine)

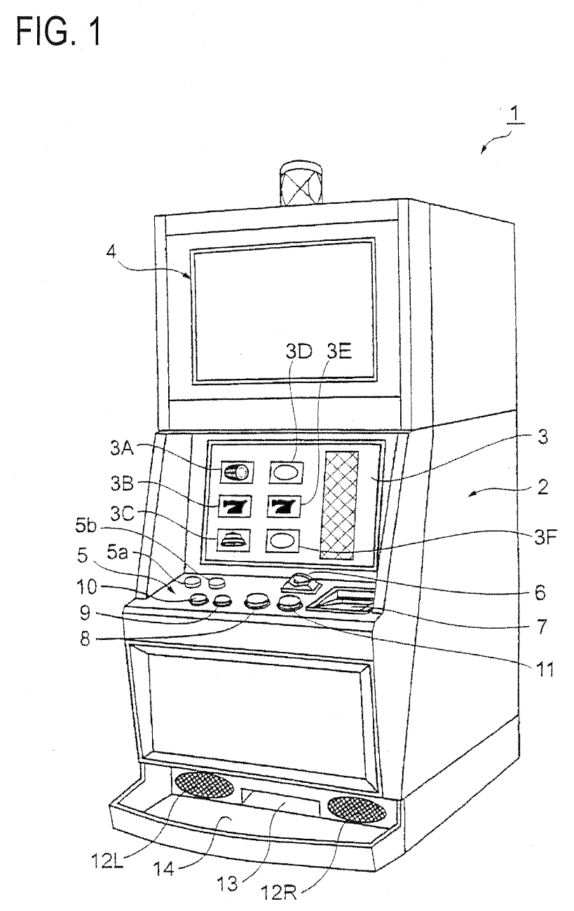

As shown in FIG. 1, a slot machine (gaming machine) 1 includes a cabinet 2 which contains electronic or mechanic devices used to execute slot games (games). A main display 3 constructed from LCD (Liquid Crystal Display) is arranged in front of the cabinet 2. Also, a sub display 4 constructed from LCD is arranged on upper side of the main display 3.

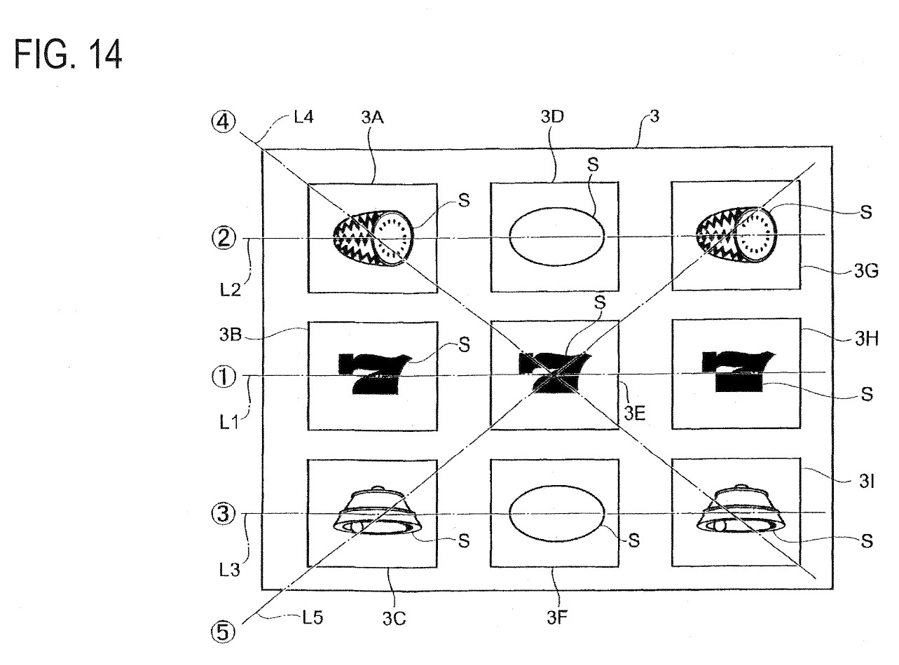

Nine symbol display areas 3A, 3B, 3C, 3D, 3E, 3F, 3G, 3H, and 31 (see FIG. 14) are arranged on the main display 4 with 3×3 matrix shape. Scrolled images in which plural kinds of symbols are moving from up to down (reel images displayed as the mechanic reels are rotating) are displayed on symbols display areas 3A to 31 in a base game mode.

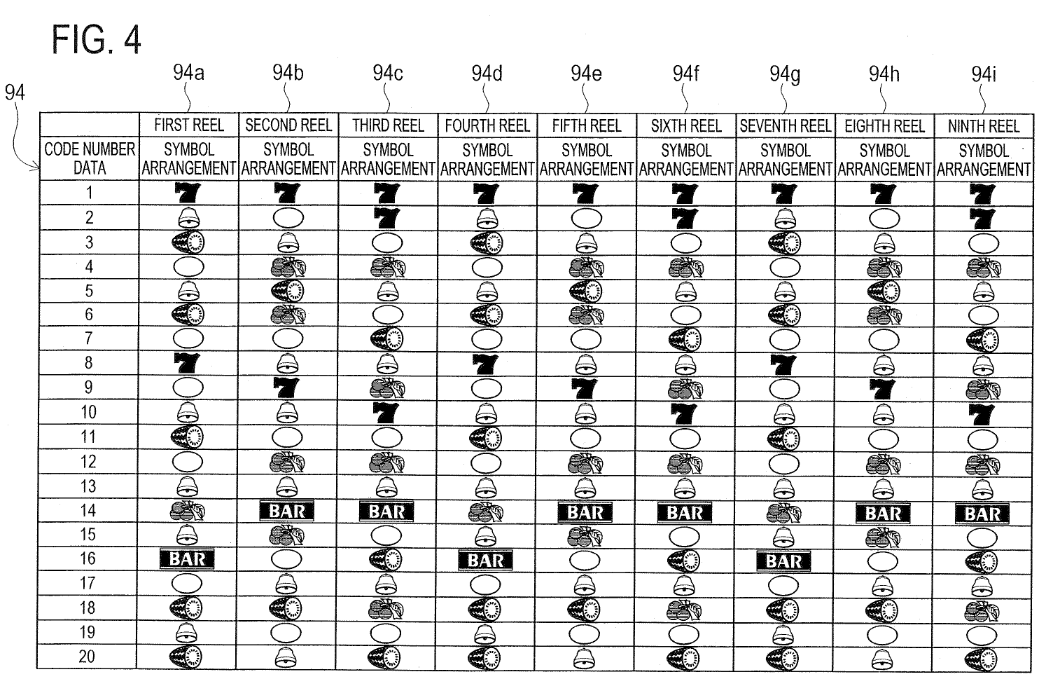

Symbols included in symbol arrangement 94a of a first reel (see FIG. 4) are scrolled and displayed from the top repeatedly on symbol display area 3A (arranged on left-upper side of the main display 3). After the scrolled display, one symbol S among the symbol arrangement 94a are stopped and displayed.

Symbols included in symbol arrangement 94b of a second reel are scrolled and displayed from the top repeatedly on symbol display area 3b (arranged on left-middle side of the main display 3). After the scrolled display, one symbol S among the symbol arrangement 94b are stopped and displayed.

In similar way, a symbol display area 3C corresponds to symbol arrangement 94c of a third reel. Also, a symbol display area 3D corresponds to symbol arrangement 94d of a fourth reel. Also, a symbol display area 3E corresponds to symbol arrangement 94e of a fifth reel. Also, a symbol display area 3F corresponds to symbol arrangement 94f of a sixth reel. Also, a symbol display area 3G corresponds to symbol arrangement 94g of a seventh reel. Also, a symbol display area 3H corresponds to symbol arrangement 94h of an eighth reel. Also, a symbol display area 3I corresponds to symbol arrangement 94i of a ninth reel.

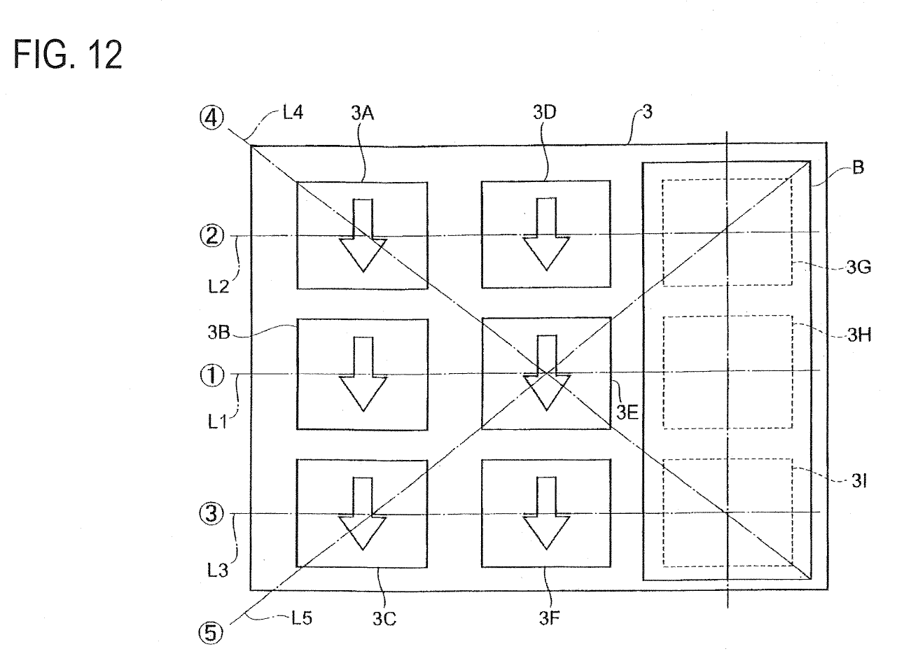

As shown in FIGS. 12 to 14, a first payline L1 is arranged to connect a second symbol display area 3B, a fifth symbol display area 3E, and an eighth symbol display area 3H. In a similar way, a second payline L2 is arranged to connect the first symbol display area 3A, a fourth symbol display area 3D, and a seventh symbol display area 3G. Also, a third payline L3 is arranged to connect the third symbol display area 3C, the sixth symbol display area 3F, and the ninth symbol display area 3I. Also, a fourth payline L4 is arranged to connect the first symbol display area 3A, a fifth symbol display area 3E, and a ninth symbol display area 31. Also a fifth payline L5 is arranged to connect the third symbol display area 3C, a fifth symbol display area 3E, and a seventh symbol display area 3G.

In the embodiment, all of paylines L1 to L5 are activated and winning combination(s) are determined based on combination of three symbols S which are arranged on each of the paylines L1 to L5, regardless of the number of inserted coins or the like. Symbols stopped and displayed on the paylines L1 to L5 correspond to symbols of the winning combinations.

Here, one or more aspects of present invention may be constructed to determine activated paylines L1 to L5 based on the number of inserted coins. For example, if one coin is inserted to a coin insertion slot 6, the payline L1 may be activated. If two coins are inserted to the coin insertion slot 6, the paylines L1, L2, and L3 may be activated. If three coins are inserted to the coin insertion portion 6, all of the paylines L1 to L5 may be activated. In this case, symbols displayed on activated paylines can construct any of the winning combinations.

Images related to the payout table, explanations of the game and the like (for example, explanations of the game content) are displayed on the sub-display 4. Also, effect images of when a free game trigger is realized (for example, letter image of “FREE GAME GET”) or the like are display on the sub-display 4.

In the slot machine 1, a base portion 5 which is almost horizontal is arranged under the main display 3. The coin insertion slot 6, a bill insertion portion 7, a spin switch 8, a I-BET switch 9, a max-BET switch 10 and a CASHOUT switch 11 are arranged on the base portion 5. Further, a shielding selection switch 5a and a shielding cancel switch 5b are arranged on the base portion 5.

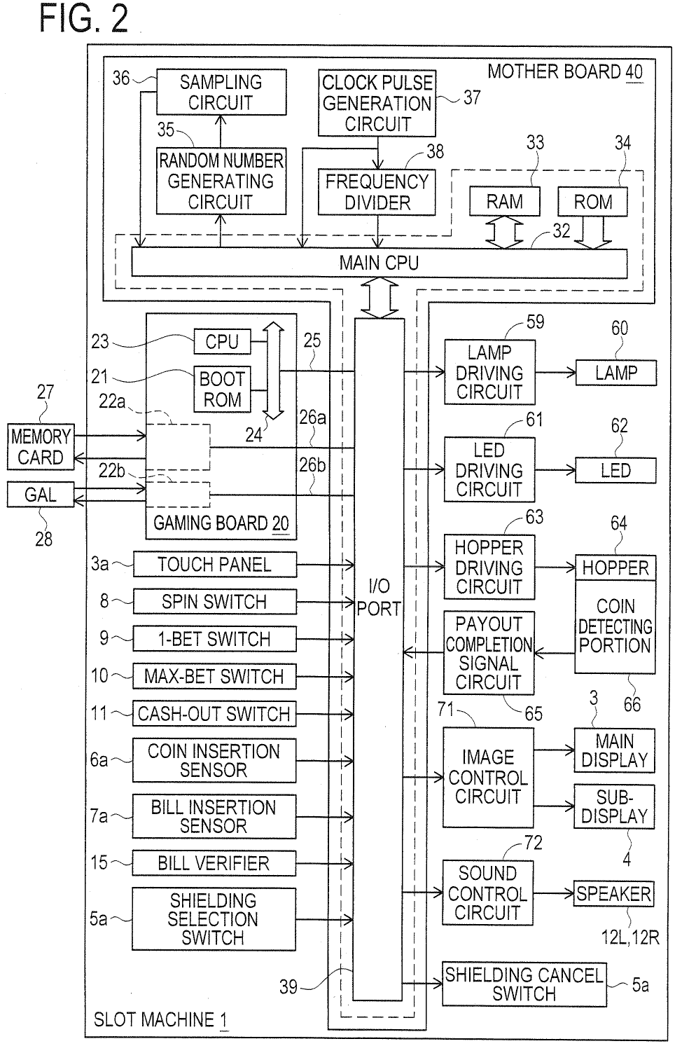

The coin insertion slot 6 is arranged to be inserted coins betted by the player to the game. The coin insertion slot 6 includes a coin sensor 6a (see FIG. 2) to output signals for showing coin insertion. The bill insertion portion 7 is arranged for the player to insert bills. The bill insertion portion 7 includes a bill insertion sensor 7a to output the signals for bill insertion.

The spin switch 8 is arranged for a player to execute the operation to start a slot game by displaying the scrolled images of symbols. The 1-Bet switch 9 is arranged to bet one coin for one bet operation. The max-bet switch 10 is arranged to bet a maximum of coins which may be betted in one game for one bet operation. The CASHOUT switch 11 is an operation button to payout the credited coins to a coin receiving portion 14.

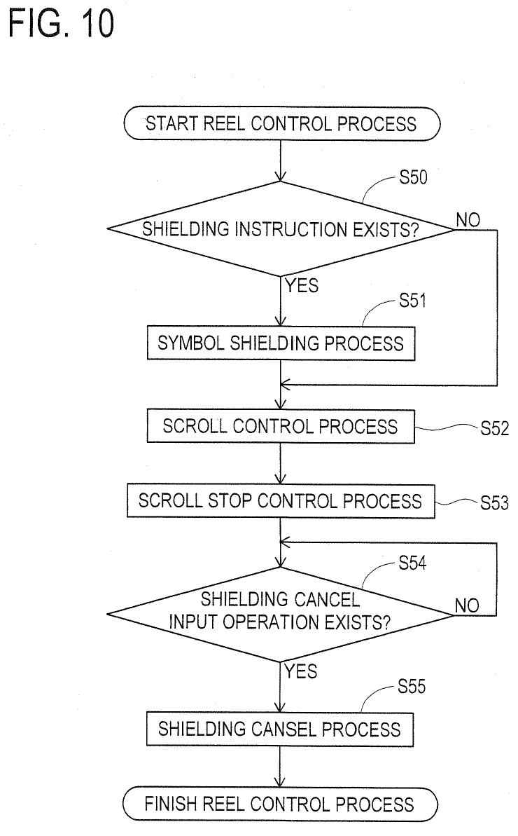

Also, the shielding selection switch 5a is a shielding operation button to execute a symbol shielding process (see FIG. 10, which will be described later). The shielding cancel switch 5b is a shielding cancel button to display symbols S shielded in the symbol shielding process.

Furthermore, in the slot machine 1, a coin payout opening 13 and a coin receiving portion 14 to receive the paid out coins are arranged at the bottom part of the cabinet 2. Also, a speaker 12L and 12R is arranged on the either side across the coin payout opening 13.

FIG. 2 is a block diagram showing an internal construction of the slot machine 1. The slot machine 1 includes plural construction elements which are centered on a gaming board 20 and a mother board 40.

The gaming board 20 includes a CPU 23, a boot ROM 21, card slots 22a and 22b. The CPU 23 is connected with the boot ROM 21 by the internal bus 24. Each of the card slots 22a and 22b is corresponding to a memory card 27 and a GAL 28 respectively. The gaming board 20 is a device used to import the after-mentioned game programs to the mother board 40 from the memory card 27. The gaming board 20 is a device used to import the payout ratio setting data from the GAL 28.

The CPU 23 and the boot ROM 21 are connected to the mother board 40 by the PCI bus 25. And the CPU 23 and the ROM 21 are connected with each other by the internal bus 24. The signal transmission between the mother board 40 and the gaming board 20 is executed by a PCI bus 25, and the power supply from the mother board 40 to the gaming board 20 is executed by the PCI bus 25. An after-mentioned verification program, a preliminary verification program, and a program for the CPU 23 to boot the preliminary verification program (not shown, boot code) are stored in the boot ROM 21.

The verification program is executed to check whether the gaming data being the object of the verification read process is falsified or not. And the verification program is written along the procedure for the verification of the gaming data. A game program and a game system program are supplied to the slot machine 1 via the memory card 27. The verification program is the program used to verify the first game program by the CPU 32. The verification is a program used to check whether the game program and game system program are falsified or not. Therefore, it is also called falsification check program.

A preliminary verification program is used to verify whether the above verification program is falsified or not. The preliminary verification program is written along the procedure for the check of falsification of the verification program. In other words, verification program is used to verify the game program, and preliminary verification program is used to verify the verification program. The preliminary verification program is executed by the CPU 23.

The card slot 22a is connected to the mother board 40 by an IDE bus 26a. The card slot 22a is connected to the memory card 27 in a state in which the stored game program is in a readable state. The card slot 22a is a slot (mechanical connection) to which the memory card may be inserted.

The card slot 22b is connected to the mother board 40 by an IDE bus 26b. The card slot 22a is connected to the GAL 28 in a state in which the stored payout ratio setting data is in a readable state. The card slot 22b is a slot (mechanical connection) to which the GAL 28 may be inserted.

The mother board 40 is constructed from general mother board (printed board which mounts basic components of a personal computer), and includes a main CPU 32 (the first and the second gaming progress control means), a ROM 34, a RAM 33, an I/O port 39, a random number generating circuit 35, a sampling circuit 36, a clock pulse generation circuit 37, a frequency divider 38. And the above PCI bus 25 and IDE bus 26a and 26b are connected to the I/O port 39.

The main CPU 32 is executed based on the imported game program and game system program. The input and output of the signals to the other elements are executed by the main CPU 32 via the I/O port 39, the performance control of the entirety slot machine 1 is also executed by the main CPU 32.

The data and the programs to boot the main CPU 32 are stored in the RAM 33. And also the verification program read through the gaming board 20, the game program, and the game system program are stored in the RAM 33.

The programs including the BIOS executed by the main CPU 32 (the standard BIOS in the mother board 40) and the perpetual data are stored In the ROM 34. When the BIOS is executed by the main CPU 32, the initial process for predetermined peripheral devices is executed, and the read process for the game program stored in the memory card 27 is started via the gaming board 20. Memory devices such as flash memories are used in the ROM 34, the memories in which the contents are rewritable or not rewritable may be used in the ROM 34.

The random number generating circuit 35 is run based on the instruction of the main CPU 32. And a predetermined range of random numbers is generated by the random number generating circuit 35. The sampling circuit 36 is run based on the instruction of the main CPU 32. An arbitrary random number is extracted from the random numbers generated in the random number generating circuit 35, and the extracted random number is input to the main CPU 32. The basic clock pulse to run the main CPU 32 is generated by the clock pulse generating circuit 37. And the signal in which the basic clock pulse is divided in a predetermined frequency is input to the main CPU 32 by the frequency divider 38.

Furthermore, the slot machine 1 includes a touch panel 3a, a lamp driving circuit 59, a lamp 60, a LED driving circuit 61, a LED 62, a hopper driving circuit 63, a hopper 64, a payout completion signal circuit 65 and a coin detection portion 66. Also the slot machine 1 includes an image control circuit 71 and an audio control circuit 72.

The touch panel 3a is arranged to cover the screen of the main display 3. The position to which the player's fingers touched is detected by the touch panel 3a, and the position signal corresponding to the detected position is input to the main CPU 32. Therefore, the player may execute the input operation by the touch operation of fingers through the touch panel 3a.

The signals to light the lamp 60 is output by the lamp driving circuit 59, and the lamp 60 is flashed during the progressing of the game (gaming session). The effect of the game is executed by the flashing of the lamp 60. The flashing of the LED 62 is controlled by the LED driving circuit 61. The number of coins credited and the number of coins obtained are displayed by the LED 62.

The hopper 64 is driven by the hopper driving circuit 63 based on the control of the main CPU 32. And the payout of coins is executed by the hopper 64. Coins are paid out from the payout opening 13 to the coin receiving portion 14.

The number of coins paid out by the hopper 64 is calculated by the coin detection portion 66, and the data of the calculated number is notified to the payout completion signal circuit 65.

The data of the number of coins from coin detection portion 66 is input by the payout completion signal circuit 65. When the number of coins reaches a predetermined number, the signal to notify the completion of coins is input to the main CPU 32.

Image display on the main display 3 and the sub-display 4 is controlled by the image control circuit 71. Scrolled images of plural symbols, effect images of the game effects, and various images including the status images which are used to notify the game status to the players, are displayed on the main display 3 and the sub-display 4.

The image control circuit 71 includes image control CPU 71a, a work RAM 71b, a program ROM 71c, an image ROM 71d, a video RAM 71e, and VDP (Video Display Processor) 71f. The image control CPU 71a determines images to be displayed on the main display 3 and the sub-display 4 (scrolling images, the images of the symbols stopped and displayed after the display of the scrolling images) according to the image control program based on the parameter which is set by the main CPU 32. The work RAM 71b functions as temporary storage when the image control CPU 32 executes the image control program.

The program ROM 71c stores image control program, various selection tables, or the like. The image ROM 71d stores dotted data to form image. The dotted data includes symbol image data indicating each symbol used in the slot table, for example. The video RAM 71e functions as a temporary storage when the images are formed by the VDP 71f. The VDP 71f includes a control RAM 71g, and forms images corresponding to display content of the main display 3 and the sub display 4 which are determined by the image control CPU 71a.

Audio signals for outputting the sound from the speaker 12L and 12R are input to the speaker 12L and 12R by the audio control circuit 72. From the speaker 12L and 12R, for example, the sound to boost the game mood at an appropriate timing after the game is started, is output.

Also, the slot machine 1 includes the shielding selection switch 5a and the shielding cancel switch 5b. The shielding selection switch 5a switches to either “ON” state or “OFF” state based on player's operation. If the state is “ON”, the shielding selection switch 5a inputs “ON” signal to the main CPU 32. On the other hand, if the state is other than “ON”, the shielding selection switch 5a inputs “OFF” signal to the main CPU 32. The shielding cancel switch 5b inputs the shielding cancel signal to the main CPU 32 based on the player's input operation.

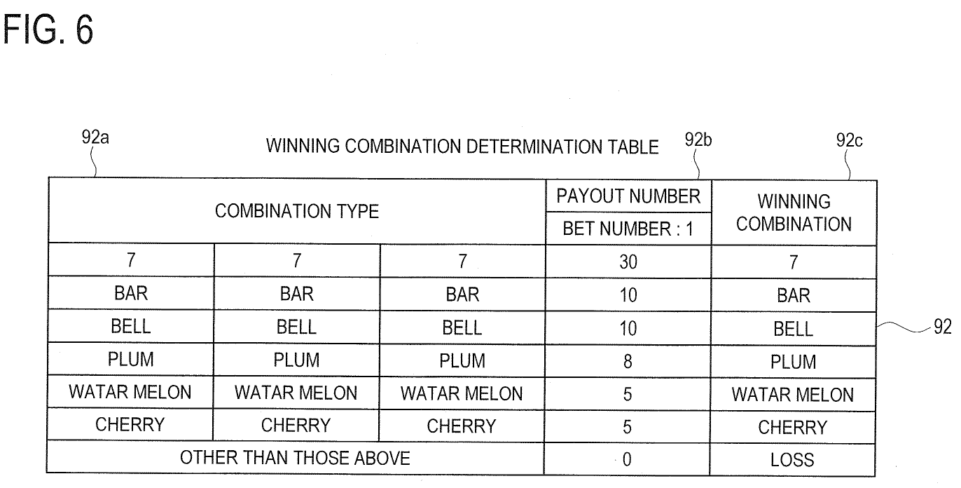

The winning combination determination table 92 shown in FIG. 6 is stored in the RAM 33 of the mother board 40. The winning combination determination table 92 is referred when the main CPU 32 makes winning combination determination for combination of symbols and determination for the payout number of winning combination. The winning combination determination table 92 includes combination type area 92a, a payout number area 92b, and a winning combination area 92c. Each of the areas is associated each other. The winning combination determination table 92 sets winning combination of symbols in the slot machine 1. If the combination of symbols realized any of the winning combination stored in the winning combination table 92, the coins with the payout number will be provided to the player.

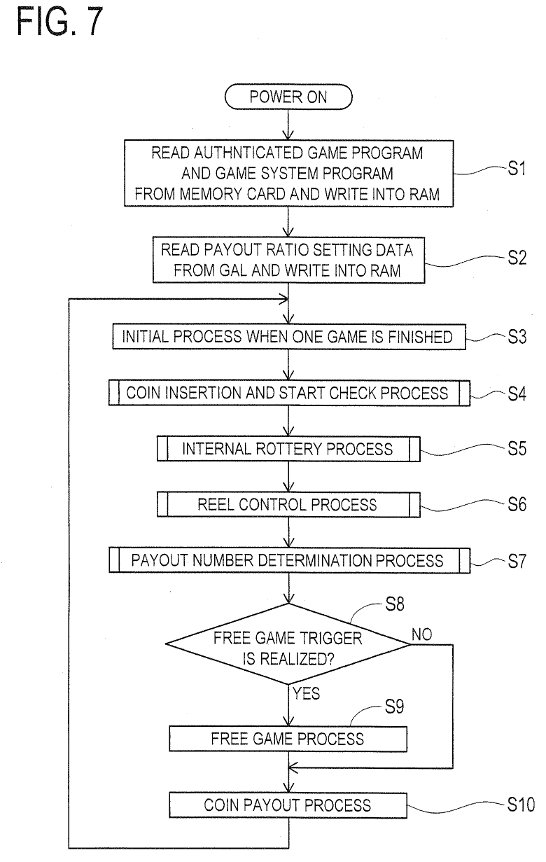

For example, if the combination of symbols on the payline L1 is “7” “7” “7”, the winning combination of “SEVEN” is realized and 30 coins are provided. Also, the main CPU 32 determines that the winning combination is “SEVEN”, a free game trigger is realized and a free game process (see FIG. 7) which will be described later is executed.

In the slot machine 1 as mentioned above, the main CPU 32 controls slot gaming session. Hereinafter, control processes of the slot machine 1 will be described with reference to FIGS. 7 to 11. FIG. 7 is a flowchart indicating operation procedure of the main control process repeatedly executed in the main CPU 32 after the power is ON.

### (Operation Procedure of the Main Control Process)

When the main control process is started with the booting of the system, the procedure is shifted to S3 after S1 and S2 are executed. And then, the procedure is shifted to a routine in which each step from S3 to S10 is repeated and executed in sequence.

In S1, the BIOS stored in the ROM 34 is executed, and the verification program is read out from the boot ROM 21 and stored in the RAM 33, by the main CPU 32 of the slot machine 1. Furthermore, based on the verification program, the verification process of the game program and the game system program stored in the memory card 27 are executed by the main CPU 32, and the game program and the game system program are read out via the gaming board 20. The read-out game program and the game system program are written in the RAM 33, and the game program and the game system program are executed by the main CPU 32.

In S2, the payout ratio setting data stored in the GAL 28 is read out by the main CPU 32 via the gaming board 20. And the read-out payout ratio setting data is written in the RAM 33.

In S3, the initial process for starting a new slot game is executed by the main CPU 32. The initial process is a process to clear the data items set in a predetermined data area. And the initial process is executed each time one game of the slot game is terminated. Next, in S4 to S7, the coin insertion and the start check process, the internal lottery process, the reel control process and the payout number determination process are executed in sequence. Here, the slot game is executed in a base game mode.

Next, in S8, when the free game trigger is realized in the base game mode, the main CPU 32 shifts the game mode from the base game mode to the free game mode and shifts the procedure to S9. And then, the free game is executed. The free game is executed one or plural times by the main CPU 32. And after the execution of the free game process, the procedure is shifted to S10. If the free game trigger is not realized during the base game mode, the procedure is directly shifted to S10 without executing the S9.

In S10, the payout process of coins is executed, and coins are paid out directly or indirectly by the main CPU 32. When the CASHOUT switch 11 is “ON”, the hopper 64 is driven and coins with a predetermined number are paid out to the coin receiving portion 14 by the main CPU 32. On the other hand, when the CASHOUT switch 11 is “OFF”, credits with a predetermined number are added to the credit number counter by the main CPU 32, therefore, an indirect payout process is executed. That is, coins are indirectly provided.

If ON signal is input from the CASHOUT switch 11, the main COU 32 set “1” indicating directly payout in the CASHOUT flag allocated in the RAM 33. If OFF signal is input from the CASHOUT switch 11, the main CPU 32 set “0” indicating indirectly payout in the CASHOUT flag allocated in the RAM 33. The main CPU 32 determines whether or not the CASHOUT switch 11 is “ON” based on the value which is set in the CASHOUT flag.

### (Coin Insertion and Start Check Process)

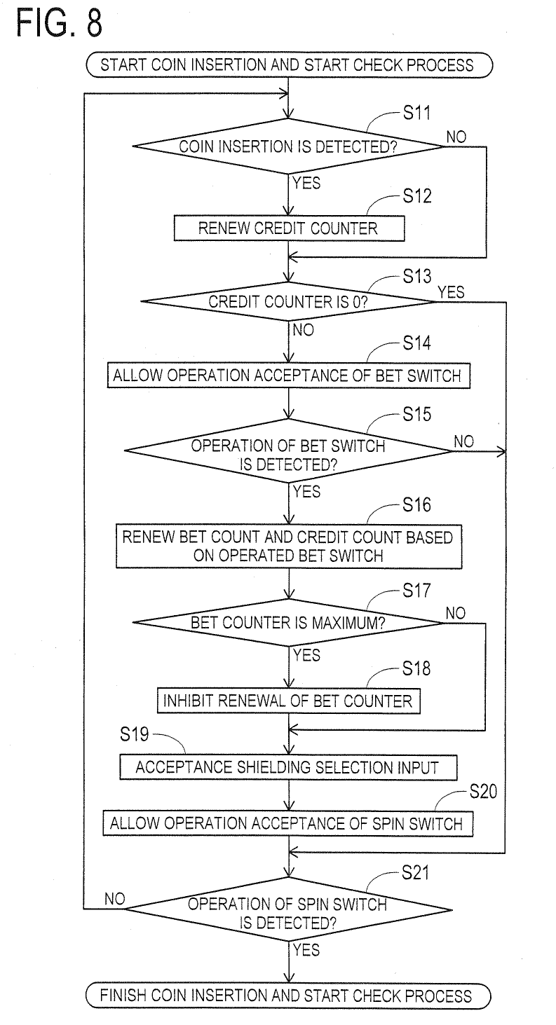

The coin insertion and start check process in S4 is executed according to the flowchart shown in FIG. 8. When the coin insertion and start check process is started by the main CPU 32 in the slot machine 1, the procedure is shifted to S11. In S11, it is determined whether or not coins are inserted by the input of the signals from the coin insertion sensor 6a. When the coin insertion is detected by the main CPU 32, the procedure shifted to S12, and after the execution of S12, the procedure is shifted to S13. However, when the coin insertion is not detected by the main CPU 32, the procedure is shifted to S13 without executing S12.

In S12, the credit number counter is renewed (the credits corresponding to the inserted coins are added). The credit number counter is used to show the remaining value of the credits which is constructed from coins inserted or coins to be paid out.

In S13, it is determined whether or not the credit number counter is “0”. When the credit number counter is “0”, the procedure is shifted to S20. When the credit number counter is not “0”, the procedure is shifted to S14. In S14, the operation acceptance of the bet switch (1-bet switch 9 and the max-bet switch 10) is allowed.

In S15, it is determined whether or not the operation of the bet switch (betting operation) is detected by the CPU 32. When either betting operation is detected, the procedure is shifted to S16, and when none of betting operation is detected, the procedure is shifted to S21. In S16, based on the bet switch in which the operation is detected, the bet number counter showing the bet number of coins and the credit number counter are renewed. In other words, the bet number shown in the bet number counter is increased, or the credit number shown in the credit number counter is decreased.

In S17, it is determined whether or not the number shown in the bet number counter becomes the maximum. When the number shown in the bet number counter becomes the maximum, the procedure is shifted to S18, a process in which renewing of the bet number counter is forbidden is executed, and then the procedure is shifted to S19. When the number shown in the bet number counter is not the maximum, the procedure is shifted to S19 without executing S18.

In S19, the main CPU 32 accepts an operation of shielding selection. That is, if the input signal from the shielding selection switch 5b is “ON” signal, “1” indicating shielding instruction by the player is set to the shielding selection flag. Also, if the input signal from the shielding selection switch 5b is “OFF” signal, “0” indicating shielding instruction by the player is not input is set to the shielding selection flag.

In S20, the main CPU 32 allows the operation acceptance of the spin switch 8. In S21, it is determined whether or not the operation of the spin switch 8 is detected by the main CPU 32. If the operation of the spin switch 8 is detected, the coin insertion and start check process is finished. If the operation of the spin switch 8 is not detected, the procedure is returned to S31, and the above processes are repeated.

### (Internal Lottery Process)

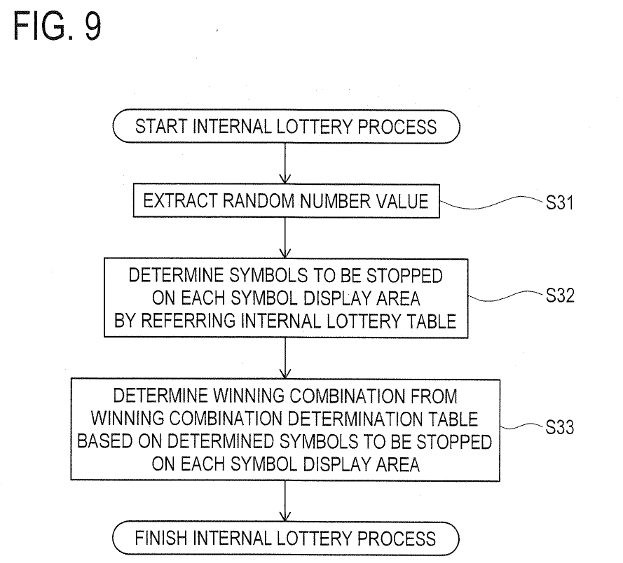

When the coin insertion and start check process is finished, the procedure is shifted to S5 shown in FIG. 7, the internal lottery process is executed. The internal lottery process is executed by the CPU 32 according to the flowchart shown in FIG. 9.

When the internal lottery process is started by the CPU 32, the procedure is shifted to S31. In S31, instructions are transmitted to the sampling circuit 36, and arbitrary random numbers are extracted from the random numbers generated by the random number generating circuit 35. In S32, based on the random numbers extracted in S31, the symbols which are stopped and displayed on each symbol display area 3A to 3I (symbols which are to be stopped and displayed) are determined. The determination is made by referring to the internal lottery table (not shown). Here, the extraction of the random number is executed nine times to each symbol display area 3A to 31. And the determination for the symbols which are to be stopped and displayed is also executed nine times to each symbol display area 3A to 3I.

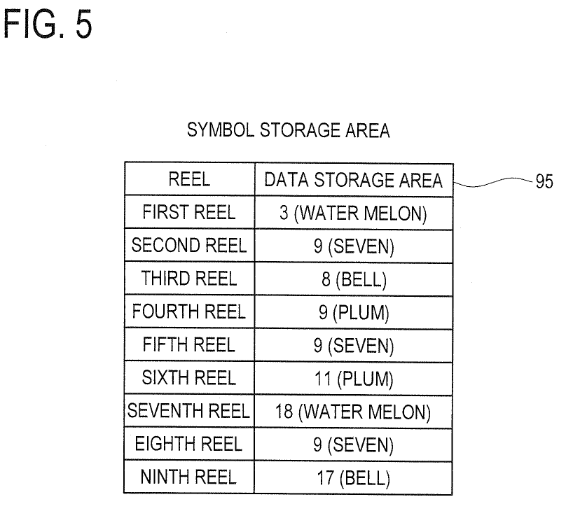

After symbols S to be stopped and displayed on each of the symbol display areas 3A to 31, symbol data corresponding to the symbols are stored in symbol storage areas 95 (see FIG. 5) allocated in the RAM 33. FIG. 5 shows code number data (see FIG. 4) corresponding to symbol arrangements 94a to 94i of the first to the ninth reels as symbol data. The main CPU 32 stops symbols S on each of the symbol display areas 3A to 31 based on symbol data in reel control process. Here, the example of FIG. 5 corresponds to FIG. 14. The “WATER MELON” symbol is stopped on the first symbol display area 3A corresponding to the first reel. The “SEVEN” symbol is stopped on the second symbol display area 3B corresponding to the second reel. The “BELL” symbol is stopped on the third symbol display area 3C corresponding to the third reel. The “PLUM” symbol is stopped on the fourth symbol display area 3D corresponding to the fourth reel. The “SEVEN” symbol is stopped on the fifth symbol display area 3E corresponding to the fifth reel. The “PLUM” symbol is stopped on the sixth symbol display area 3F corresponding to the sixth reel. The “WATER MELON” symbol is stopped on the seventh symbol display area 3G corresponding to the seventh reel. The “SEVEN” symbol is stopped on the eighth symbol display area 3H corresponding to the eighth reel. The “BELL” symbol is stopped on the ninth symbol display area 3I corresponding to the ninth reel.

In S33, the main CPU 32 determines the winning combination by referring the winning combination determination table 92 (see FIG. 6) with the use of the symbol data stored in the symbol storage area 95 of the RAM 33.

### (Reel Control Process)

When the internal lottery process is finished by the main CPU 32, the procedure is shifted to the S6 shown in FIG. 7. The main CPU 32 executes the reel control process according to the flowchart shown in FIG. 10.

When the reel control process is started, the main CPU 32 shifts the procedure to S50. The CPU 32 determines whether or not the shielding instruction by the player exists. If “1” indicating that the shielding instruction exists is set in the shielding selection flag, S51 is executed. If “0” indicating that the shielding instruction does not exist is set in the shielding selection flag, S52 is executed without executing S51.

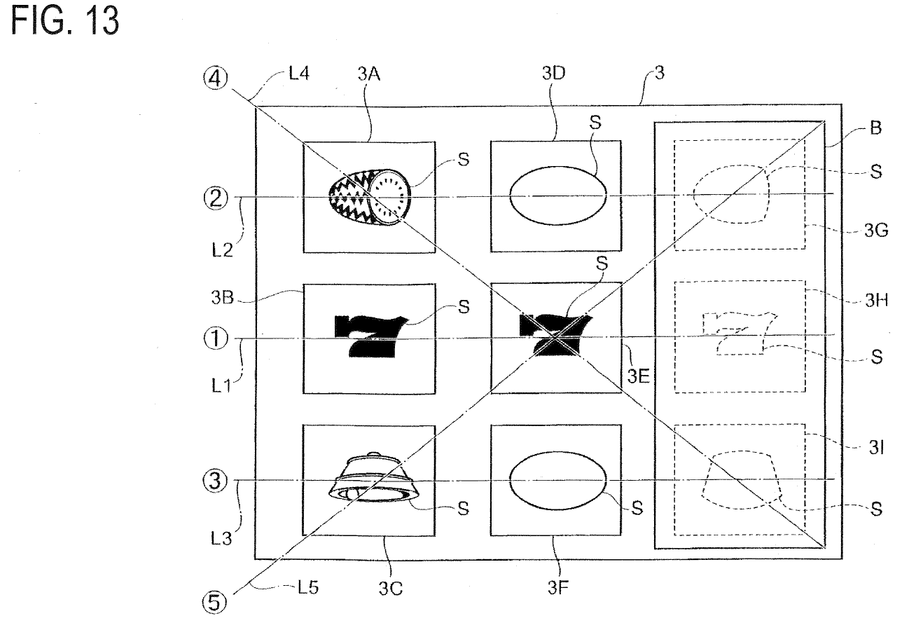

In S51, the main CPU 32 executes a symbol shielding process. In the symbol shielding process, the CPU 32 shields scrolled images and symbols to be displayed on the seventh to ninth symbol display areas 3G, 3H, and 3I so as to prevent the player from recognizing symbols, by instructing to the image control circuit 71, as shown in FIGS. 12 and 13. For example, the main CPU 32 may cover all of the seventh to ninth symbol display areas 3G, 3H, and 31 with another image B to hide the symbol S. The main CPU 32 may display background image on a part of the main display 3 corresponding to the seventh to ninth symbol display areas 3G, 3H, and 3I. Here, only if the combination of symbols to be displayed constructs a reach pattern, the main CPU 32 can execute the symbol shielding process. Here, the reach pattern means that at least two symbols among three symbols to be displayed on paylines L1 to L5 construct a part of any of the winning combinations.

In the embodiment, since symbols S to be stopped on the seventh to ninth display area 3G to 3I, the player can not recognize symbols S on all of the paylines L1 to L5. That is, if symbol S to be stopped and displayed on the seventh symbol display area 3G, the player can not recognize the symbol to be stopped on payline L2 and the payline L5. Also, if symbol S to be stopped and displayed on the eighth symbol display area 3H, the player can not recognize the symbol to be stopped on payline L1. Also, if symbol S to be stopped and displayed on the ninth symbol display area 31, the player can not recognize the symbol to be stopped on payline L3 and the payline L4.

As a result, the player can not directly recognize whether or not the winning combination is realized until the symbols S are stopped and displayed on the seventh to ninth symbol display areas 3G to 3I in the shielding cancel process (S55) which will be described later.

In S52, the main CPU 32 displays scrolled images (see FIG. 12) on the first symbol display area 3A to the sixth symbol display area 3F (namely, other than display area 3G to 31 shielded in the symbol shielding process) by instructing to the image control circuit 71. In FIG. 12, the scrolled images are indicated by downward arrows. Further, the CPU 32 sets stop timers of the first reel to the sixth reel respectively corresponding to the first symbol display area 3A to the sixth symbol display area 3F. Here, if the symbol shielding process is not executed, the CPU 32 displays scrolled image on the first symbol display area 3A to the ninth symbol display are 31, and sets stop timers of the first reel to the ninth reel respectively corresponding to the first symbol display area 3A to the ninth symbol display area 3I.

In S53, the main CPU 32 executes scroll stop control process. The CPU 32 determines whether or not each stop timer of the first reel to the sixth reel is “0”. And then, symbol S is stopped on the first to the sixth symbol display areas 3A to 3F corresponding to the reel of the stop timer in which “0” is set (see FIG. 13). The symbols correspond to the symbol data stored in the symbol storage area 95. If all of stop timers of the first reel to the sixth reel are “0”, the scroll stop control process is finished. Here, if the symbol shielding process is not executed, the main CPU 32 determines whether or not the seventh reel to the ninth reel is 0, in addition to the first reel 3A to the sixth reel 31. And then, symbol S is stopped on the first to the ninth symbol display areas 3A to 31 corresponding to the reel of the stop timer in which “0” is set.

In S54, the main CPU 32 waits until the shielding cancel input operation is made (namely, the shielding cancel signal from the shielding cancel switch 5b is input). Herewith, the slot gaming session is interrupted. When the shielding cancel signal is received, the procedure will be shifted to S55.

In S55, the main CPU 32 executes the shielding cancel process. In the shielding cancel process, the main CPU 32 displays symbols S on the seventh symbol display area 3G to the ninth symbol display area 31 (namely, shielded areas in the symbol shielding process), by instructing to the image control circuit 71 (see FIG. 14). The symbols S correspond to symbol data stored in the symbol storage area 95. If symbols S are displayed on the seventh to ninth symbol display areas 3G to 3I, all of stopped symbols are visible. Accordingly, the player can recognize whether or not the winning combination is realized. If the main CPU 32 displays symbols S on the seventh to ninth symbol display areas 3G to 3I, the reel control process is executed to restart the slot gaming session which is interrupted. And then, payout number determination process (see FIG. 7) and the free game process are executed. If the symbol shielding process is not executed, the reel control process is finished without executing S54 and S55.

### (Payout Number Determination Process)

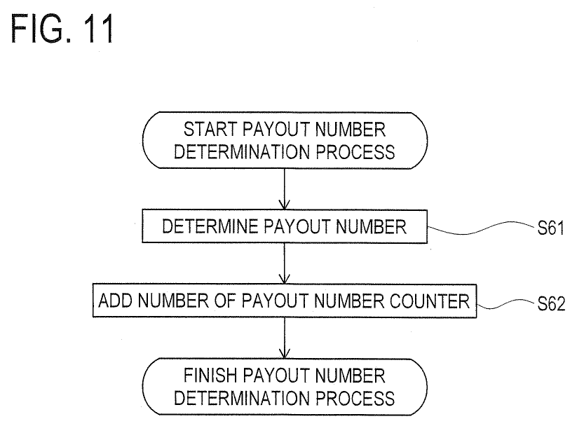

When the reel control process is finished, the procedure will be shifted to S7 shown in FIG. 7 and the payout number determination process is executed. Concretely, the payout number determination process is executed according to the flowchart shown in FIG. 11 by the main CPU 32.

If the main CPU 32 starts the payout number determination process, the procedure will be shifted to S61 and payout number is determined. Concretely, the main CPU 32 determines whether or not the combination of symbols displayed on the paylines L1 to L5 among symbols determined in the internal lottery process (see FIG. 10) constructs any of the winning combination, namely any of the winning combination is realized. If winning combination is realized, the payout number is determined based on the winning combination determination table 92 (see FIG. 6), and the procedure is shifted to S62.

That is, the main CPU 32 determines payout number and winning combination based on the combination of the symbols displayed on each payline L1 to L5 and the winning combination determination table 92. That is, if the combination of symbol data corresponding to the symbols S displayed on paylines L1 to L5 is any of the winning combination (for example, “BELL” “BELL” “BELL”), the payout number and the winning combination are extracted from the payout number area 92b and the winning combination area 92c. Also, the main CPU 32 determines the payout number and the winning combination based on the extracted data.

In S62, the payout number of coins determined in S61 is added to the payout number counter stored in the RAM 33 by the main CPU 32. Herewith, the payout number determination process is finished.

When the payout number determination process is finished, the procedure is shifted to S8 shown in FIG. 7. And in S8, it is determined whether or not the fee game trigger is realized by the main CPU 32. If the winning combination of “SEVEN” is realized in the internal lottery process, it is determined that the free game trigger is realized. And then, the procedure is shifted to S9 and the free game process is executed, and then the procedure is shifted to S10. On the other hand, if the free trigger is not realized, the procedure will be shifted to S10 without executing the free game process. When the procedure is shifted to S10, the main CPU 32 executes the coin payout process. Here, if another winning combination (for example, “BELL”) is realized, the main CPU 32 can determine that the free game trigger is realized. Also, if a predetermined symbol is stopped, the main CPU 32 can determine that the free game trigger is realized even though the winning combination is not realized.

As mentioned above, in the slot machine 1, the main CPU 32 shields some symbols among plural symbols S corresponding to the internal lottery result to be displayed on the main display 3, and interrupts the gaming session while the symbols S are shielded. And then, the main CPU 32 waits until the shielding cancel signal is input from the shielding cancel switch 5b, and if the input of the shielding cancel signal is received, the shield symbols S are displayed and the slot gaming session is restarted. Accordingly, the player can recognize the shielded symbols S on favorite timing. Also, the player can restart the gaming session on favorite timing. At a result, enjoyment of game can be enhanced.

Since the slot gaming session is interrupted, payout number determination process, the free game process, or the like are not executed even though the winning combination is realized. Accordingly, the player can not directly or indirectly recognize whether or not the winning combination is realized. Also, the player can display the shielded symbols S on the main display 3 on favorite timing, and the player can recognized whether or not the winning combination is realized on favorite timing. At a result, enjoyment of game can be enhanced.

Here, aspects of the present invention are not limited to the above embodiment and various changes and modification can be done within the scope of the present invention. For example, the number of the symbol display areas is not limited to nine, and the number of that can be three, five, or seven.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
a display configured to display symbols;
a first user interface element configured to be operated by a user;
a second user interface element configured to be operated by the user; and
a processor programmed to:
(a) shield a symbol to be displayed on the display in response to the first user interface being operated,
(b) display the shielded symbol on the display in response to the second user interface being operated,
(c) interrupt a gaming session in response to the first user interface being operated, and
(d) restart the gaming session in response to the second user interface being operated.

2. The gaming machine according to claim 1, wherein the shielded symbol is a member of a winning combination.

3. A method comprising:
(a) shielding a symbol to be displayed on a display in response to a first user interface being operated,
(b) displaying the shielded symbol on the display in response to a second user interface being operated,
(c) interrupting a gaming session in response to the first user interface being operated, and
(d) restarting the gaming session in response to the second user interface being operated.

4. The method according to claim 3, wherein the shielded symbol is a member of a winning combination.

5. A tangible computer readable medium having computer-executable instructions stored thereon that, when executed by a processor, perform a method comprising the steps of:
(a) shielding a symbol to be displayed on a display in response to a first user interface being operated,
(b) displaying the shielded symbol on the display in response to a second user interface being operated,
(c) interrupting a gaming session in response to the first user interface being operated, and
(d) restarting the gaming session in response to the second user interface being operated.

6. The tangible computer readable medium according to claim 5, wherein the shielded symbol is a member of a winning combination.
